(19) United States
(12) Patent Application Publication
(10) Pub. No.: US 2025/0186171 A1
(43) Pub. Date: Jun. 12, 2025

(54) SYSTEM AND METHOD FOR MANIPULATING TEETH WITH WIRES BONDED DIRECTLY TO TEETH

(71) Applicant: Alta Smiles LLC, Fort Washington, PA (US)

(72) Inventors: Amanda M. FRANKS, Fort Washington, PA (US); Gary D. GIEGERICH, Fort Washington, PA (US); Benjamin CASSALIA, Fort Washington, PA (US)

(21) Appl. No.: 18/845,370

(22) PCT Filed: Mar. 10, 2023
(86) PCT No.: PCT/US23/14953

§ 371 Date: Sep. 9, 2024

Related U.S. Application Data
(60) Provisional application No. 63/325,287, filed on Mar. 30, 2022.
(60) Provisional application No. 63/318,542, filed on Mar. 10, 2022.

(51) Int. Cl. A61C 7/14; A61C 7/00

(52) U.S. Cl. CPC A61C 7/146; A61C 7/002

(57) ABSTRACT

A method for moving teeth to a desired position includes the steps of collecting images of the teeth of the patient, transmitting the images to a central processor, evaluating the collected images to develop a treatment plan, and securing a wire to an anchor tooth of the teeth. The wire is secured to the anchor tooth with adhesive bonding based on the treatment plan. The wire contacts an active tooth of the teeth and is configured to move the active tooth relative to the anchor tooth.

### CROSS-REFERENCE TO RELATED APPLICATIONS

The present application claims the benefit of U.S. Provisional Patent Application Nos. 63/318,542, filed Mar. 10, 2022 and 63/325,287, filed Mar. 30, 2022, both titled, “System and Method for Manipulating Teeth with Wires Bonded Directly to Teeth,” the entire contents of which are incorporated herein by reference in their entirety.

### BACKGROUND OF THE INVENTION

Orthodontics is a relatively well established field of manipulating teeth or dealing with the prevention and correction of irregular teeth, typically by means of braces. Bracket and wires, as well as aligners are the most often used techniques to move the patient's teeth during orthodontic treatments. Removeable appliances are also used such as “retainers” that may have “spring features” to exert pressure on specific teeth while the patient is wearing the appliance. Patients desire discreet alternatives that have a minimal impact on their physical appearance.

It would be desirable to provide teeth repositioning with minimal discomfort and minimal compliance required of the patient that has minimal to no impact on the patient's physical appearance. It would be desirable to design, develop and commercialize a system and method that can be used on the buccal or lingual surfaces of the teeth that focuses treatment on the lingual side of the teeth because the orthodontic appliances described are so discreet that nobody can see them under normal circumstances.

### BRIEF SUMMARY OF THE INVENTION

Briefly stated, the preferred invention is directed to a system and method or an analysis and prediction module for moving teeth to a desired position, preferably using orthodontic wires directly bonded to teeth.

A preferred embodiment of the present invention offers a novel, useful and inventive way to provide teeth repositioning with minimal discomfort and minimal compliance required of the patient. While the system and method can be used on the buccal or lingual surfaces of the teeth the preferred embodiment focuses treatment on the lingual side of the teeth because the orthodontic appliances described in this application are preferably so discreet that nobody can see them under normal circumstances when meeting the patient.

Wires may be mounted to one tooth and use the distortion force of the wire bonded to one tooth to move an adjacent tooth by having the wire apply forces to the adjacent tooth and urge the adjacent tooth toward and into a desired location and orientation. It has been known to mount brackets to the patient's teeth and connect the brackets with wires that apply forces to the teeth through the wires and brackets to align the patient's teeth. The preferred invention incorporates several elements and refinements to directly bond wires to the patient's teeth that enable scalability, particularly when used in conjunction with a preferred camera system and treatment techniques utilizing images captured from the preferred camera system. The directly bonded wires utilize a wire directly bonded to an anchor tooth and active portions of the wire that contact a surface of an active tooth to apply forces, thereby shifting the teeth into alignment with each other.

Briefly stated, the preferred invention may be directed to a method for moving a patient's teeth, including an anchor tooth and an active tooth, to a desired position. The method may include the steps of positioning an anchor portion of an orthodontic wire onto a lingual side of the anchor tooth, positioning an active portion of the orthodontic wire onto a lingual side of the active tooth and bonding the anchor portion to the anchor tooth such that the active portion of the orthodontic wire applies a force to the active tooth to move the active tooth relative to the anchor tooth. The active portion is in facing engagement with or is contacting a surface of the active tooth.

In another aspect, the preferred invention may be directed to a method for moving a patient's teeth, including a first anchor tooth and a second anchor tooth, to a desired position. The method may include the steps of positioning a first anchor portion of an orthodontic wire onto a lingual side of the first anchor tooth, positioning a second anchor portion of the orthodontic wire onto a lingual side of the second anchor tooth, bonding the first anchor portion to the first anchor tooth and bonding the second anchor portion to the second anchor tooth. The orthodontic wire includes a spring portion between the first anchor portion and the second anchor portion to draw the first and second anchor teeth toward each other.

### BRIEF DESCRIPTION OF THE SEVERAL VIEWS OF THE DRAWINGS

The foregoing summary, as well as the following detailed description of preferred embodiments of the instruments, devices and methods of the present application, will be better understood when read in conjunction with the appended drawings. For the purposes of illustrating the system and method for manipulating teeth with wires bonded directly to teeth, there are shown in the drawings preferred embodiments. It should be understood, however, that the application is not limited to the precise arrangements and instrumentalities shown. In the drawings:

FIG. 1 is a top plan view of an exemplary tray that may be utilized with the preferred system and method for manipulating teeth with wires bonded directly to teeth in accordance with a preferred embodiment of the present invention;

FIG. 2 is a view of an exemplary comparison card or measurement guide that may be utilized with the preferred system and method for manipulating teeth with wires bonded directly to teeth;

FIG. 3A is a view of an exemplary arch direction sheet that may be utilized with the preferred system and method for manipulating teeth with wires bonded directly to teeth;

FIG. 3B is a view of an exemplary treatment form that may be utilized with the preferred system and method for manipulating teeth with wires bonded directly to teeth;

FIG. 3C is a view of an image form that may be utilized with the preferred system and method for manipulating teeth with wires bonded directly to teeth;

FIG. 4 is an occlusal view of a portion of a patient's teeth and gums with an orthodontic wire bonded to an anchor tooth and opposite ends of the orthodontic wire in contact with and applying forces to adjacent active teeth in a double activation configuration;

FIG. 5 is an occlusal view of a portion of a patient's teeth and gums with an orthodontic wire bonded to an anchor tooth and an opposite end of the orthodontic wire in contact with and applying a force to an active tooth in a single activation configuration; and

FIG. 6 is an occlusal view of a portion of a patient's teeth and gums with an orthodontic wire having a central spring and opposing ends bonded to adjacent anchor teeth.

### DETAILED DESCRIPTION OF THE INVENTION

Certain terminology is used in the following description for convenience only and is not limiting. Unless specifically set forth herein, the terms “a”, “an” and “the” are not limited to one element but instead should be read as meaning “at least one”. The words “right”, “left”, “lower” and “upper” designate directions in the drawings to which reference is made. The words “inwardly” or “distally” and “outwardly” or “proximally” refer to directions toward and away from, respectively, the patient's body, or the geometric center of the preferred system for manipulating the teeth of a patient with wires bonded directly to the teeth and related parts thereof. The words, “anterior”, “posterior”, “superior,” “inferior,” “lateral,” “lingual,” “buccal,” “facial,” “mesial,” “occlusal,” “mandibular,” and related words and/or phrases designate preferred positions, directions and/or orientations in the human body or the patient's mouth to which reference is made and are not meant to be limiting. The terminology includes the above-listed words, derivatives thereof and words of similar import.

It should also be understood that the terms “about,” “approximately,” “generally,” “substantially” and like terms, used herein when referring to a dimension or characteristic of a component of the preferred invention, indicate that the described dimension/characteristic is not a strict boundary or parameter and does not exclude minor variations therefrom that are functionally the same or similar, as would be understood by one having ordinary skill in the art. At a minimum, such references that include a numerical parameter would include variations that, using mathematical and industrial principles accepted in the art (e.g., rounding, measurement or other systematic errors, manufacturing tolerances, etc.), would not vary the least significant digit.

### Step 1—Diagnostic Image Capture

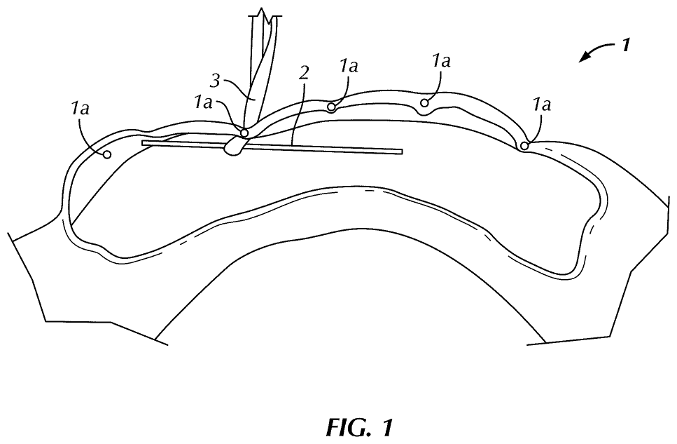

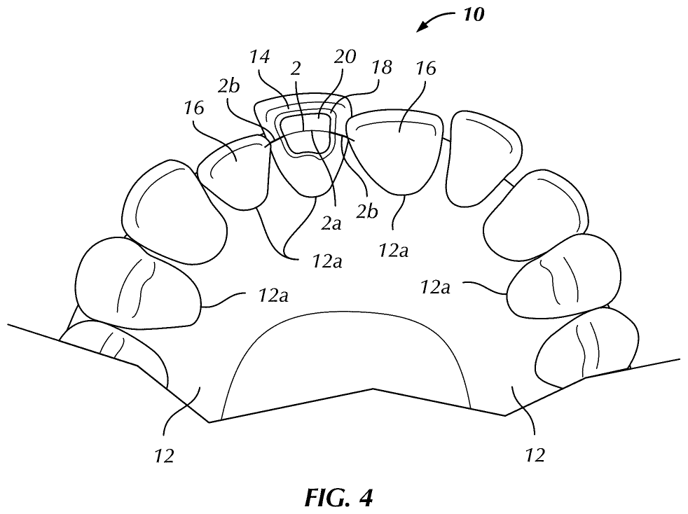

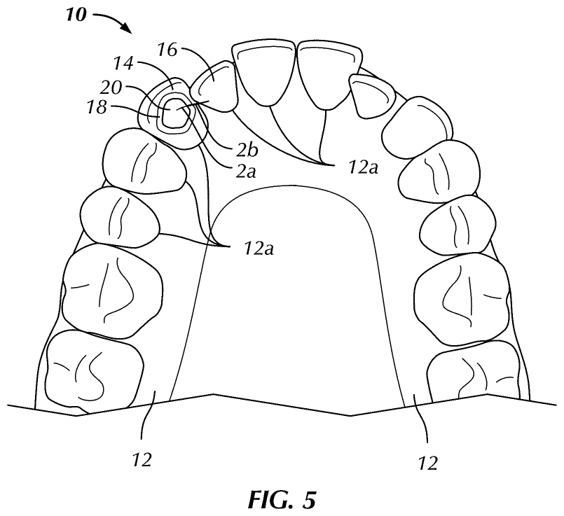

Referring to FIGS. 1-6, in the preferred embodiment a three-dimensional (“3D”) image of a patient's teeth is created using an intra-oral scanner or by taking a physical impression and scanning the impression to create a 3D file or model 10 of the patient's teeth and gums and two-dimensional (“2D”) images of the patient's teeth and arches are also taken. The 3D file or model 10 is 2D images of the patient's teeth and arches alone is also an acceptable option, but the 3D images are preferred for creating the file or model 10. The collected 2D images of the patient's teeth and gums may be utilized to create the 3D file or model 10 of the patient's teeth and gums for orthodontic treatment planning purposes. Referring to FIGS. 4-6, the 3D file or model 10 preferably includes the number of teeth on an upper and/or lower arch, the positioning and orientation of the teeth and the gums 12, the size and shape of the patient's teeth and the positioning of the patient's gums 12 relative to the patient's teeth, particularly the positioning of the patient's gum line 12a. The portions of the patient's arch shown in FIGS. 4-6 also represent the anatomy of the patient's arches in addition to representing the 3D model 10 of the portion of the patient's arches.

The intra-oral scanner and physical impressions utilized to create the 3D file or model 10 are preferably utilized at an initial appointment for the patient to develop a baseline for the positioning of the patient's arches and are preferably not utilized at later dental appointments. Later or subsequent dental appointments preferably utilize the collection of 2D images to track and determine the positioning of the patient's teeth and movement of the teeth based on the orthodontic treatment plan. The 2D images may be collected during the patient's dental appointment during the orthodontic treatment plan, may be collected by the patient prior to the dental appointment and transmitted to the central processor or may be otherwise collected, transmitted and analyzed. An image form 24 may be utilized to guide the patient or dental professional in collecting images of the patient's teeth and arches prior to or during an orthodontic appointment. The image form 24 preferably includes patient identifiers, such as patient name, and a date for the images. The image form 24 of the preferred embodiment suggests a center open, a center closed, a left buccal, an upper arch, a right buccal and a lower arch images, although this sequence and listing of images is not limiting and the image form 24 may include more or less suggested images for collection. The images are preferably transmitted with the image form 24 to the central processor for evaluation of movement of the patient's teeth and update or modification of the orthodontic treatment plan based on the movement.

Step 2 Evaluation of Desire Initial Tooth Movements and/or Sequence of Movements

Evaluating desired tooth movements by a dental clinician based on the 3D file or model 10 is then preferably conducted. The clinician may be (but does not need to be) the person who performs the actual clinical procedures. In fact, the clinician may be a computer or central processor that evaluates the images and/or the 3D file or model 10 to create or develop an orthodontic treatment plan. Preferably the clinician moves one or more teeth within a 3D treatment planning software associated with the 3D file or model 10 to plan incremental tooth positions and final tooth positions. The desired movements may be one of: (1) rotating, (2) up-righting, (3) leveling, (4) tilting, (5) creating space between teeth, (6) closing spaces between teeth or (6) any other movement or manipulation of the teeth to shift the teeth from their existing positions to and toward their final preferred positions based on the orthodontic treatment plan. The clinician preferably also evaluates the sequence of which teeth to move during what times during the orthodontic treatment plan and expected or projected timing of the orthodontic treatment plan. The clinician or central processor also preferably modifies, updates or changes the orthodontic treatment plan based on interim images of the patient's teeth that are collected and evaluated during dental appointments during the orthodontic treatment plan.

### Step 3 Selection of the Appropriate Hardware and Determining the Positioning of Hardware on the Teeth

In order to properly select and position the optimal hardware to affect the desired movements in Step 2, the clinician preferably evaluates the forces necessary to optimally move the teeth using a technique of positioning and rigidly securing a segment of the orthodontic wire 2 on one or more anchor teeth 14 and having the wire 2 touching one or both of the adjacent teeth or active/target teeth 16. The wire 2 is preferably not bonded to the active tooth 16 but is positioned in engagement with the active tooth 16 such that the wire 2 applies force to the active tooth 16 to move the position of the active tooth 16 relative to the anchor tooth 14. The wire 2 touching the active tooth 16 is deformed or bent from its original position and because of its flexible “memory wire” construction exerts continuous pressure on the active tooth 16 to move the active tooth 16 relative to the anchor tool 14. The anchor tooth 14 may move over time during the orthodontic treatment but the active tooth 16 typically moves more than the anchor tooth 14. The wire 2 preferably contacts and is slidable on a surface of the active tooth 16 while applying forces to move the active tooth 16 relative to the anchor tooth 14 such that the anchor tooth 14 and active tooth 16 are urged toward a final position and orientation based on the orthodontic treatment plan.

Determining the desired wire 2 and position of the wire 2 on both the active tooth 16 and anchor tooth 14, preferably results from an analysis (1) the distance between the two teeth 14, 16, (2) an angular position of the two teeth 14, 16 relative to each other, (3) the density of the jaw bone, (4) the morphology of the teeth 14, 16 or the root structure of the teeth 14, 16 and related factors of the teeth 14, 16, other adjacent teeth, arches, patient's medical history and related factors that guide the clinician in determining the desired wire 2, size of the wire 2, length of the wire 2 and position of the wire 2 when developing the orthodontic treatment plan or modifying/updating the orthodontic treatment plan.

Part of the evaluation process involves determining a desired height or positioning of the wire 2 relative to a gum line 12a and generally on the anchor tooth or teeth 14 and the active tooth or teeth 16, which can vary from tooth-to-tooth both in initial placement and modifications to the orthodontic treatment plan mid-treatment. In the preferred embodiment, the wire 2 may be affixed to the anchor tooth 14 and touches the active tooth 16 such that the wire 2 is generally parallel to the gum line 12a of the patient but preferably not touching the gums 12 or is oriented generally horizontally within the patient's mouth when the patient is standing upright. The wire 2 preferably does not touch the patient's gums 12 to avoid and limit irritation of the patient's gums 12 and soft tissue during treatment. The wire 2 is also preferably positioned in close proximity and in facing engagement with or touching the surface of the anchor tooth 14 and the active tooth 16 to limit potential irritation of the patient's tongue during the orthodontic treatment.

It should be noted that some wires 2 may be placed to stabilize specific teeth without necessarily driving a movement of the teeth relative to each other or to additional teeth. Wires 2 used for this stabilization purpose may be either flexible or rigid. When the wires 2 are placed to stabilize the teeth, the wires 2 are preferably bonded to the teeth by adhesive bonding to maintain the positioning of the teeth relative to each other and generally not to urge movement of the teeth.

The wires 2 may be constructed of nitinol, stainless steel or another metal or may be made of a plastic or polymer material or other materials that are generally strong, stiff, biocompatible and are able to withstand the normal operating conditions of the wires 2 utilized in the system and method described herein. In the preferred embodiment there are a total of approximately twenty-seven (27) different wires 2, although this specific number of wires 2 is not limiting, that have varying qualities and features including:
thicknesses (from 0.008-0.16), shapes (round, square or rectangular)
Length
Straight wires or curved wires
Variable flexibility wires that may be utilized in different oral cavities or situations because of the higher temperature.
A wire with one or more U-Shaped curves or springs that are used to close spaces between teeth by applying a compression force between the teeth to draw the teeth together or close a gap between the teeth.
A wire with a flared or wider portion attached to or formed with the wire. Such flared or wider portion may be on either end of the wire and can provide a wider area of contact to engage the Active Tooth more fully and/or create additional torque. This generally flared or wider portion may be utilized for bonding or for engagement with a surface of the tooth without bonding.

A clinician may utilize a measurement guide 22 to confirm selection of the correct wire 2 based on the orthodontic treatment plan by comparing the selected wire 2 to images of the wires on the measurement guide 22 to confirm the correct wire 2, as is described in greater detail below.

The evaluation of the preferred system and method can be done by a human using prior experiences and estimations or preferably utilizing computer modeling to calculate the physics of the force exertions to develop or modify the orthodontic treatment plan. Such inputs lead to the selection of the optimal hardware (such as wires 2, bonding adhesive 18 and related hardware) and placement of the hardware in specific locations on the teeth, assist in making or developing specific orthodontic treatment plans or adjusted orthodontic treatment plans for the patient and make other decisions regarding treatment plans, timing and hardware or equipment that may be utilized with the preferred system and method for the patient.

### Step 4 Documentation

Documentation of initial desired wire selection and placement is also implemented with the preferred system and method. Such documentation is preferably stored on a network or in a central processor which is accessible to the clinician who may place the wire 2, but documentation may also be done manually. Documentation will preferably include:
Anchor Tooth 14 and Active Tooth 16 designations
Hardware selection
Desired position of the wire 2 relative to the gum line 12a (distance from gum line)
Other documentation and record keeping that are desirable or required by regulatory authorities or insurance providers related to the preferred system and method.

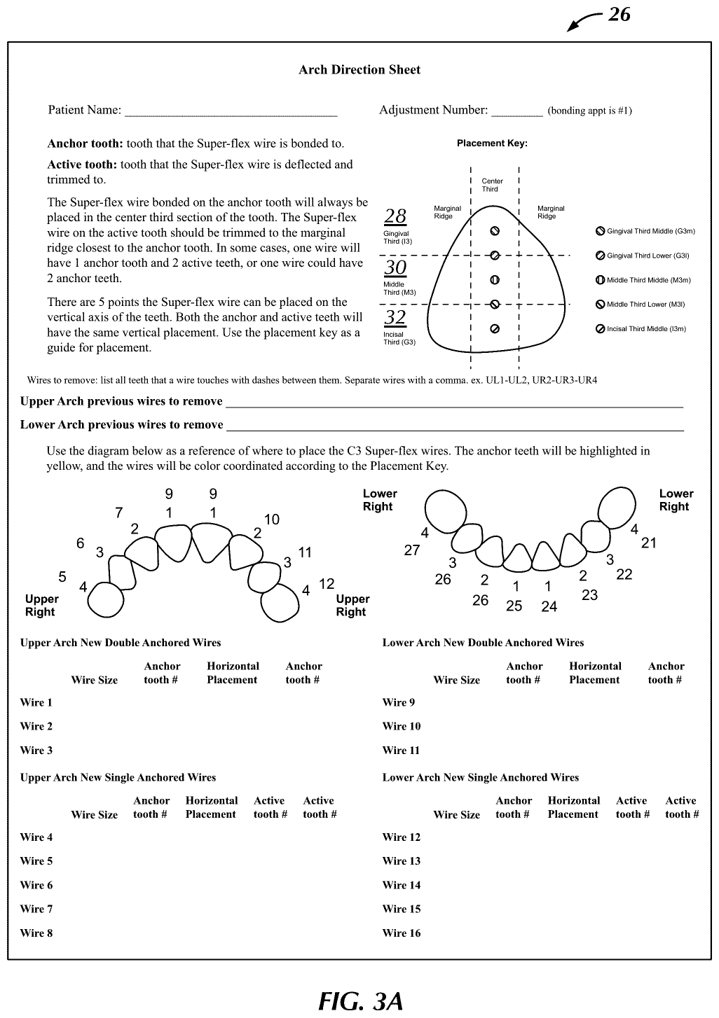

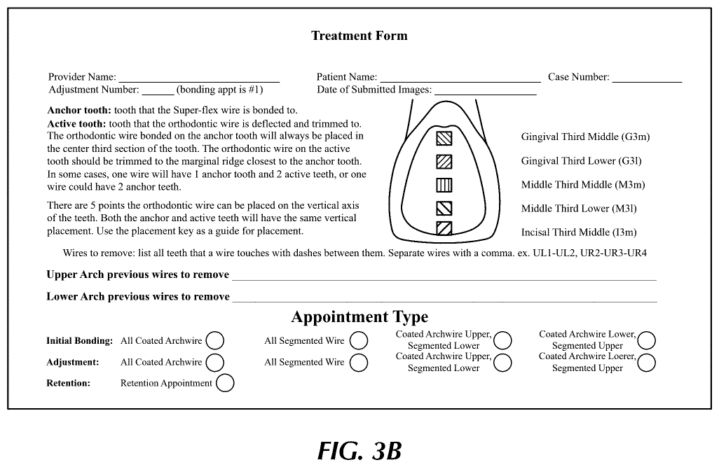

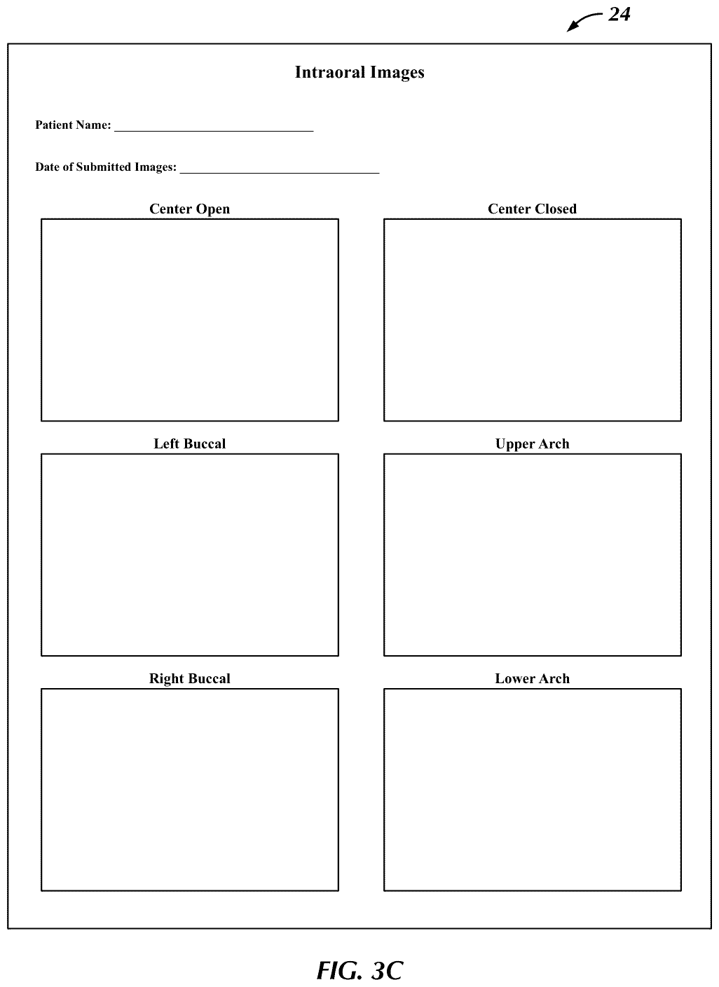

The documentation may include a single initial recommendation but may also include a series of incremental recommendations based on expected movements of the patient's teeth during the course of treatment. An attached arch direction sheet 26 (See FIG. 3A) provides a non-limiting example of documentation that may be utilized with the preferred system and method. The preferred arch direction sheet 26 includes information related to positioning of the wire 2 on the tooth, the specific teeth where the wires 2 should be associated, areas where wires 2 should be removed and additional information regarding the positioning, placement and removal of the wires 2 in accordance with the orthodontic treatment plan. The positioning of the wires and information related to the wires 2 of the arch direction sheet 26 is directed to the preferred embodiment and is not limiting.

In the preferred embodiment displaying the recommendations of the system and method in one of a variety of visual formats is utilized, which can include text or diagrams. Such displaying may use color coding of the recommendations regarding horizontal or general positioning of the wires 2 so that the orthodontic treatment plans are easy to understand and recognize the desired positions of the teeth and the wires 2.

### Step 5 Placement of the Appliance(s)

A clinician preferably places the wires 2 on a patient's teeth in accordance with the treatment plan documented in Step 4 above. Using a bondable and flowable adhesive 18, such a 3M Transbond LR which is not limiting and the system and method may utilize any adhesive 18 that is biocompatible, functions in accordance with the described methods herein and is able to withstand the normal operating conditions of the adhesive 18, the pre-selected wire(s) 2 is bonded to the patient's anchor tooth or teeth 14, which is/are comprised of the anchor teeth 14 in the preferred embodiment. The wires 2 can be placed by hand preferably by using a dental plier (not shown) or a flexible material 3 to hold the wire 2 since the wires 2 are small and would be difficult to hold without the plier. If the wire 2 selected is too long based on the orthodontic treatment plan it can be manually trimmed using a wire cutter (typically referred to as a ligature cutter)(not shown). The trimming is preferably done after the wire 2 is affixed to the teeth, typically the anchor tooth 14 or anchor teeth 14, but can be done before. Alternatively, the flexible, thin strand of material, such as dental floss 3, may be pressed between two teeth such that the material 3 is in the shape of a loop. The looped portion of the dental floss 3 is placed such that it is on same side of the teeth, preferably the lingual side, as the wire 2 will be placed. The wire 2 is then placed within the loop of the floss 3. The clinician then pulls the non-looped ends of the flexible material 3 thus exerting pressure on the wire 2 to move toward the teeth 14, 16 which holds the wire 2 in place relative to the teeth 14, 16.

### Placement Device for Positioning and Placing of the Hardware/Wires

Referring to FIG. 1, the system may utilize a tray or guide 1, which may be constructed of a polymeric or plastic material that is molded for utilization with the patient's arches and is designed and configured specifically to the patient's teeth and arches based on the 3D model 10. The tray or guide 1 preferably includes slots 1a for engagement with dental floss 3 or other flexible string-like materials 3 for holding the wires 2. In addition, the tray or guide 1 is preferably shaped and oriented relative to the patient's teeth to properly position the wire 2 at the predetermined location on the patient's teeth in accordance with the treatment plan developed for the patient. The tray 1, slots 1a and/or wires 2 may include flat edges or curved portions that make it easier for the wires 2 to be oriented properly relative to the tray 1 and the patient's teeth during operation. (See images of tray 1 with slots 1a with dental floss 3 wrapped around a segment of orthodontic wire 2 and the dental floss 3 positioned by the slots 1a of FIG. 1).

Based on a 3D model 10 of the patient's teeth and arches, a device/appliance, tray or guide 1 is fabricated that nests over two or more of the patient's teeth. This custom appliance or tray 1 provides physical guidance and positioning for the clinician while applying the wire 2 to the desired position. The appliance or tray 1 has one or more recesses, slots or voids 1a that align with the spaces between the patient's teeth. The slot or void 1a is preferably configured such that the depth of the slot 1a corresponds with the clinician's recommendation of where to place the wire 2 relative to the gum line 12a, which is preferably at a middle third of the anchor tooth 14. The slots or voids 1a can be of a consistent depth for all the teeth or may vary from tooth to tooth based on clinician preferences or clinical needs. Using a piece of flexible material such as dental floss 3, the flexible material 3 is placed in the slot 1a utilizing the technique described as an option in Step 5 above.

### Optional Features of Placement Device

The device or tray 1 may have an optional recess or tongue guard (not shown) into which the patient's tongue is placed while the wires 2 are being bonded. The tongue guard preferably keeps the patient's tongue physically away from the lingual tooth surfaces, the slots 1 and the wires 2 during installation or application of the wires 2 to the patient's teeth. An opening in the tongue guard may be connected to a suction tube that can suction saliva during bonding, thus increasing the likelihood that a dry tooth surface can be maintained during the procedure.

The preferred tray 1 may have contours such that the tray 1 temporarily holds the wires 2 within the tray 1 prior to the placement of the wires 2. For example, such contours may allow the wires 2 to snap into the tray 1 or into the slots 1a along the elongated portion of the wire 2 or may provide friction on the two distal ends of the wire 2. The tray 1 may also utilize the flexible material 3 to hold the wire 2 in position in the tray 2 prior to bonding to the patient's teeth. The tray 1 may also include a reservoir holding the adhesive 18 or a guide for the clinician to facilitate or direct application of the adhesive 18 onto the anchor portion 2a of the wire 2 when bonding the wire 2 to the anchor tooth 14. The reservoir and guide assist the clinician in directing a predetermined amount of the adhesive 18 onto a predetermined location on the anchor portion 2a and the anchor tooth 14 to bond the wire 2 to the anchor tooth 14. The tray 1 also preferably protects or guards the adhesive 18 from the environment in the patient's mouth to promote curing of the adhesive 18, such as by keeping the surface of the anchor tooth 14, the adhesive 18 and the anchor portion 2a dry during the curing process. The tray 1 may further include features that promote curing of the adhesive 18, such as curing lights, heating elements or other features that promote curing of the adhesive 18 once applied to the anchor tooth 14 and the anchor portion 2a.

The guide or tray 1 may also have an apparatus for holding the wire 2 in position within a recess into which adhesive 18 is placed prior to application of the wire 2 and adhesive 18 to the patient's teeth. Once the adhesive 18 is cured onto the anchor tooth 14 to secure the wire 2 to the anchor tooth 14, the guide or tray 1 is removed and the wire 2 dislodges from the guide 1. This exemplary embodiment is similar to a retention tray for positioning wires 2.

### Subsequent Refinements or Adjustments to the Treatment Plan

Subsequent refinements and modifications to the orthodontic treatment planning as the treatment plan advances is contemplated, such that the patient's treatment may be accelerated, decelerated or otherwise altered based on progress of the movement of the patient's teeth. The treatment wires 2 may be incrementally modified to an adjusted or alternate orthodontic treatment plan by a remotely located orthodontist or the central processor involving: capturing of at least one new image of the patient's teeth, evaluation of treatment progress and incremental recommendations by the clinician or central processor (human or computer) based on the new images, and recommendations that may include one of removing wires 2 previously bonded, or removing and repositioning (which includes replacing) of the wire 2 relative to the gum line 12a, placing new wires 2 on any number of teeth, utilizing the active tooth 16 and anchor tooth 14 designations or other treatment options that are designated based on analysis by the clinician resulting from the updated images taken of the patient's teeth. Such image(s) are preferably taken by the patient at home or nearly anywhere prior to the dental appointment but may be taken in-office. Such images include at least one of buccal center, buccal left, buccal right, maxillary occlusal, mandibular occlusal, center open, center closed, upper arch, lower arch or other images that will assist the clinician in making updated treatment plan suggestions.

### Storing the Treatment Recommendation in a Network

Updated treatment records are preferably stored on a network accessible to the clinician performing the procedure. The clinician preferably affixes the wires 2 in accordance with the revised or updated orthodontic treatment plan by the clinician resulting from the updated images.

### Optional Additional Hardware

The clinician may place a “wedge” on the wire 2 or tooth for treatment. In order to create additional torque to help move the target tooth 16 the wedge may be placed on either the anchor or target tooth 14, 16. The preferred purpose of the wedge is to elevate the wire 2 in an ideal location so that the memory wire 2 is deformed more than it would be without the wedge and will exert additional tension on the target tooth 16. Such wedge may be in any shape or size, as long as the wedge is able to withstand the normal operating conditions of the wedge described herein and perform the preferred functions of the wedge. The wedge can be custom made to fit the morphology of the teeth or may be a standard size that may be selected and applied by the clinician. The wedge may be created by using a custom form that fits over the occlusal surface of a patients tooth with the form including a recessed area that outlines the desired shape of the wedge. A flowable bonding material or adhesive 18 may be placed into the recess of the form so that the wedge is custom fabricated and simultaneously applied directly to the tooth surface. In this way, the wedge is shaped ideally for the specific tooth.

It may also be desirable to have mounting pads or wire positioning guides 20, which are small appliances that are placed and bonded directly to the buccal or lingual surface of the anchor tooth and to an anchor portion 2a of the wire 2. The anchor portion 2a of the wire 2 is bonded to the wire positioning guide 20, rather than directly on the surface of the anchor tooth 14 or the anchor portion 2a is bonded in combination with the wire positioning guide 20 to the anchor tooth 14. The wire positioning guides 20 may enhance the treatment process in multiple ways, including providing a barrier between the tooth surface and the wire 2 to avoid potential abrasions to the anchor tooth 14, providing a more consistent surface to bond the wire 2 to the anchor tooth 14, providing enhanced guidance as to the desired placement of the wire 2 by incorporating reference points into the structure of the wire positioning guide 20, providing additional surface area for bonding, conforming the size and shape of the wire positioning guide 20 to the size and shape of the anchor tooth 14 or otherwise marking the wire positioning guide 20 or the wire 2 and additional enhancements. The wire positioning guide 20 may have grooves into which the wire 20 can be placed prior to applying the bonding material or adhesive 18, thereby further enhancing the guidance and placement of the wires 2 relative to the wire positioning guide 20 and the anchor tooth 14. The wire positioning guide 20 may be custom or one of a variety of standard designs.

### Quality Control

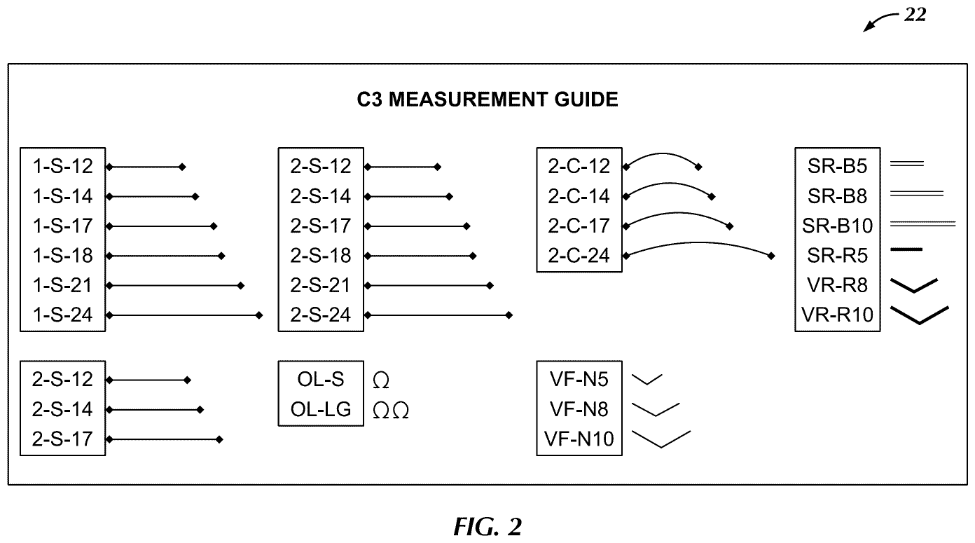

As the wires 2 bonded to the teeth are relatively small, selection of the appropriately sized wire 2 may be difficult for the clinician to ensure that the wires 2 selected for application to the patient's teeth are the correct ones prior to bonding the selected wires 2 to the teeth or placement of the wires 2 against the teeth. Many of the wires 2 appear the same to the naked eye and can even be difficult to identify under magnification. There are several techniques and methods that can improve the accuracy of the selection of wires 2 that are applied to the teeth. Such methods include applying a unique color coating onto the wires 2 or a printed identifier code. Such coating or print may be dissolvable once the wire 2 is applied to the teeth or following a relatively limited amount of time upon exposure to the patient's mouth. In the preferred embodiment a comparison card or measurement guide 22, an example of which is shown in FIG. 2, may be utilized to assist the clinician in selecting the wires 2 that are applied to the patient's teeth. The comparison card or measurement guide 22 is preferably printed with actual sized images of a desired series of wires 2, wherein color coding and sizing indications may be utilized. With the comparison card or measurement guide 22, the clinician may manually place an actual wire 2 on the comparison card 22 and compare the physical properties of the wire 2 to the likeness or image of the wire on the comparison card 22 to ensure that the selected wire 2 is the wire 2 desired by the clinician. This same procedure can also be performed by displaying the actual sized wire on a screen so that the comparison can be done by holding the wire 2 against the screen for comparison. A combination of color coating and use of the printed comparison card 22 may also be used to confirm that the selected wire 2 is the correct wire 2 for the procedure indicated by the orthodontic treatment plan. In the preferred embodiment, the selected orthodontic wire 2 is compared to images of orthodontic wires on the measurement card 22 to determine if the orthodontic wire 2 is the desired orthodontic wire of the orthodontic treatment plan.

### Multi-Modality Care Model

The preferred invention may be used as a multi-modality model which utilizes the preferred system and method in conjunction with either bracket and wire and/or clear aligner orthodontic appliances before, during or after treatment with the wires 2. As an illustrative example, a patient may begin treatment utilizing the described invention with the wires 2 bonded to or in engagement with the lingual side of the teeth and then at some point during treatment have the wires 2 removed and commence treatment with either braces or aligners. In another exemplary scenario one or more of the wires 2 may continue to be affixed to the teeth and aligners are used simultaneously, e.g., fitted over the wires 2, preferably with relief windows formed or defined in the aligners to accommodate the wires 2. In another illustrative scenario the wires 2 may be used on one of the patient's arches while either bracket and wire or aligners are used on the other arch. More complicated cases my utilize inter-arch elastics, or intra-arch elastics that utilize a fixed appliance such as a button or bracket that enables elastics use.

The system and method may also utilize artificial intelligence (“AI”) and machine learning to determine optimal positioning for the wires 2 utilizing any of the techniques and systems described herein. The preferred system and method may also utilize a camera with a positioning device to take images for either the initial images or during the course of treatment. The images may also be utilized to confirm correct placement of the wires 2 on the anchor teeth 14 and the target teeth 16 and bonding of the wires 2 to the anchor teeth 14.

The preferred system and method may utilize dynamic treatment planning (updating treatment plan based on new 2D images that are used to update a 3D file and then create an updated orthodontic treatment plan).

In operation, the preferred invention is directed to a method for moving a patient's teeth, including the anchor tooth 14 and the active tooth 16, to a desired position. The clinician positions the anchor portion 2a of the orthodontic wire 2 onto a lingual side of the anchor tooth 14, preferably with the anchor portion 2a and the associated wire positioning guide 20 within a center third and middle third of the anchor tooth 14. The active portion 2b of the orthodontic wire 2 is positioned onto or engaged with a surface of the active tooth 16, such that the wire 2 applies a force to the active tooth 16 but is not bonded to the active tooth 16 but is permitted to slide on the surface as the active tooth 16 moves and applies a force to facilitate movement of the active tooth 16. The anchor portion 2a is bonded to the anchor tooth 14 such that the active portion 2b of the orthodontic wire 2 applies the force to the active tooth 16 to move the active tooth 16 relative to the anchor tooth 14, in accordance with the orthodontic treatment plan. The active portion 2b is in facing engagement, in contact with or touching the surface of the active tooth 16.

The anchor portion 2a preferably includes the wire positioning guide 20 that is bonded to the anchor tooth 14 with the anchor portion 2a. The wire positioning guide 20 is preferably formed onto or bonded to the anchor portion 2a prior to bonding the wire 2 to the anchor tooth 14 but is not so limited and the wire positioning guide 20 may not be included with the wire 2 without significantly impacting the function and operation of the wire 2 and the preferred method. The wire positioning guide 20 is configured to mate with the lingual side of the anchor tool 14 and may be designed and configured to mate with the lingual surface to facilitate bonding of the anchor portion 2a to the anchor tooth 14, positioning of the anchor portion 2a relative to the anchor tooth 14 and positioning of the wire 14 relative to the anchor tooth 14 and the active tooth 16. Once the anchor portion 2a is bonded to the anchor tooth 14 with the adhesive 18, the active portion 2b of the wire 2 trimmed proximate a marginal ridge of the active tooth 16 to reduce the profile of the wire 2 and limit irritation of the patient's gums 12 and soft tissue from exposure to the end of the active portion 2b. The end of the active portion 2b may also be manipulated and smoothed to further limit sharp edges or corners that could irritate the patient's soft tissue.

In a double activation configuration, the anchor portion 2a is positioned centrally on the orthodontic wire 2 and is preferably bonded to the lingual side of the anchor tooth 14 in the center third and middle third of the anchor tooth 14. This preferred configuration of the orthodontic wire 2 has an active portion 2b including a first active end 2b and a second active end 2b (FIG. 4) and the active tooth 16 includes a first active tooth 16 and a second active tooth 16. The first active end 2b is in engagement with the first active tooth 16 and the second active end 2b is in engagement with the second active tooth 16 such that the first and second active teeth 16 are urged to move by the first and second active ends 2b into alignment with the anchor tooth 14. The first and second active ends 2b are preferably in facing engagement with or contacting the first and second active teeth 16, respectively and are able to slide along the surfaces of the first and second active teeth 16 to facilitate the movement of the active teeth 16 by applying forces to move the active teeth 16 relative to the anchor tooth 14.

The anchor tooth 14 includes a gingival third section 28, a middle third section 30 and an incisal third section 32, wherein the anchor portion 2a is mounted and bonded in the middle third section 32 to the anchor tooth 14. The bonding of the anchor portion 2a is not so limited and may be otherwise mounted to the anchor tooth 14 based on the type of forces desired by the clinician or central processor, the shape and configuration of the anchor tooth 14, the shape and configuration of the active tooth 16 and the positioning of the anchor tooth 14 relative to the active tooth 16.

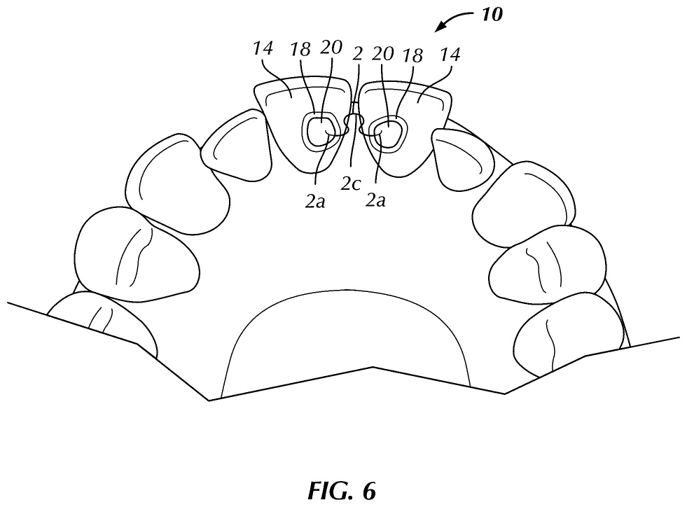

In addition, in operation, the method for moving a patient's teeth, including a first anchor tooth 14 and a second anchor tooth 14, to a desired position includes positioning a first anchor portion 2a of the orthodontic wire 2 onto a lingual side of the first anchor tooth 14 and a second anchor portion 2b of the orthodontic wire onto a lingual side of the second anchor tooth 14. The first anchor portion 2a is bonded to the first anchor tooth 14 and the second anchor portion 2a is bonded to the second anchor tooth 14. This configuration may be utilized to stabilize the two anchor teeth 14 relative to each other when the orthodontic wire 2 is relatively consistent and rigid. The orthodontic wire 2 may alternatively include a spring portion 2c between the first and second anchor portions 2a to draw the first and second anchor teeth 14 toward each other in a gap closure configuration (FIG. 6). The first and second anchor portions 2a may include first and second wire positioning guides 20 that are configured to mate with the lingual sides of the first and second anchor teeth 14 when bonded thereto, respectively. The first and second anchor portions 2a are preferably bonded to the lingual sides of the first and second anchor teeth 14 by the adhesive 18 to secure the orthodontic wire 2 with the spring 2c to the anchor teeth 14 such that the spring 2c is configured to apply a compression force between the two anchor teeth 14 to draw the anchor teeth 14 toward each other and reduce or eliminate a gap between the two anchor teeth 14.

The preferred method may also include collecting images of the patient's teeth, transmitting the images to a central processor and evaluating the collected images to develop or adjust the orthopedic treatment plan by comparing the images to the 3D model 10 or previously collected images of the patient's teeth. The orthodontic wire 2 is preferably selected based on the orthodontic treatment plan to urge the teeth into desired positions determined by the treatment plan. The images of the patient's teeth may be comprised of updated images collected at a dental appointment during the treatment, the updated images are preferably transmitted to the central processor and the updated images are evaluated to develop an updated orthodontic treatment plan. The central processor preferably utilizes the updated images to adjust the orthodontic treatment plan to develop the updated orthodontic treatment plan during the orthodontic appointment. Movement of the teeth frequently does not track with the expected movements of the teeth and the updated images may notify the clinician and the central processor that the movement of the teeth are not tracking to the original orthodontic treatment plan such that the updated treatment plan is required to urge the teeth toward the desired final positions. The central processor preferably notifies the clinician of the updated orthodontic treatment plan which may include an updated orthodontic wire 2 for bonding to the patient's teeth. The clinician may select the updated orthodontic wire 2 and compare the updated orthodontic wire 2 to the images of the wires on the measurement guide 22 to confirm that the correct orthodontic wire 2 is selected based on the updated orthodontic treatment plan. Following application of the updated orthodontic wire 2 to the patient's teeth, images may be taken of the patient's teeth with the updated orthodontic wire 2 bonded thereto and the images may be transmitted to the central processor. The central processor may compare the images to the 3D model 10 to confirm correct placement of the updated orthodontic wire 2 to the patient's teeth and positioning of the updated orthodontic wire 2.

In the preferred embodiment the active portion 2b of the orthodontic wire 2 slides across or moves relative to the surface of the active tooth 16 as the active tooth 16 moves relative to the anchor tooth 14. The active portion 2b preferably maintains engagement with the active tooth 16 during the treatment plan so that force is applied to move the anchor tooth 14 and the active tooth 16 into their final preferred positions based on the orthodontic treatment plan.

The preferred central processor may utilize machine learning and/or artificial intelligence (“AI”) to dynamically adjust the orthodontic treatment plan based on updated information from the patient or the clinician. The updated information may include images taken by the patient or the clinician during dental appointments or at predetermined times between dental appointments to monitor progress of the movements of the patient's teeth. The central processor may provide suggestions for refinements/adjustments of the orthodontic treatment plan during the course of the orthodontic treatment. Upon receiving updated images or other patient information, the network/software of the central processor may determine the relative position of two or more teeth relative to each other, examine the size and morphology of the teeth, determine a desired force dynamic to move at least one tooth relative to another, select an orthodontic wire 2 from a database of wires, determine the desired positioning of the orthodontic wires 2 and adhesive 18, determine a configuration and adhesion recommendation for the wire 2 to be directly bonded to one or more teeth and otherwise determine an updated orthodontic treatment plan for transmittal to the clinician to urge the teeth toward the desired final positions, as determined by the original orthodontic treatment plan and the 3D model 10.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the present description.

1-20. (canceled)

21. A method for moving a patient's teeth, including an anchor tooth and an active tooth, to a desired position, the method comprising:
positioning an anchor portion of an orthodontic wire onto a lingual side of the anchor tooth;
positioning an active portion of the orthodontic wire onto a surface of the active tooth;
trimming the orthodontic wire proximate a marginal ridge of the active tooth; and
bonding the anchor portion to fix the anchor portion to the anchor tooth such that the active portion of the orthodontic wire applies a force to the active tooth to move the active tooth relative to the anchor tooth, the active portion contacting the active tooth and being slidable along a surface of the active tooth.

22. The method of claim 21, wherein the anchor portion includes a wire positioning guide, the wire positioning guide bonded to the anchor tooth, the wire positioning guide configured to mate with the lingual side of the anchor tooth.

23. The method of claim 21, wherein the anchor portion is positioned centrally on the orthodontic wire, the active portion including a first active end and a second active end and the active tooth including a first active tooth and a second active tooth, the first active end in engagement with the first active tooth and the second active end in engagement with the second active tooth.

24. The method of claim 21, wherein the anchor tooth includes a gingival third section, a middle third section and an incisal third section, the anchor portion mounted in the middle third section.

25. The method of claim 21, wherein the orthodontic wire is removably attached to a slot of a tray for positioning the anchor portion onto the lingual side of the anchor tooth and the active portion onto the surface of the active tooth.

26. The method of claim 25, where a thin strand of material is wrapped around the orthodontic wire to attach the orthodontic wire to the slot.

27. The method of claim 26, wherein the thin strand of material is comprised of dental floss.

28. The method of claim 21 further comprising:
comparing the orthodontic wire to images of orthodontic wires on a measurement guide to determine if the orthodontic wire is a desired orthodontic wire of an orthodontic treatment plan.

29. The method of claim 21, wherein the anchor portion and the active portion of the orthodontic wire is positioned relative to the lingual sides of the anchor and active teeth by a tray having slots and a flexible material.

30. A method for moving a patient's teeth, including a first anchor tooth and a second anchor tooth, to a desired position, the method comprising:
positioning a first anchor portion of an orthodontic wire onto a lingual side of the first anchor tooth;
positioning a second anchor portion of the orthodontic wire onto a lingual side of the second anchor tooth;
bonding the first anchor portion to the first anchor tooth; and
bonding the second anchor portion to the second anchor tooth, the orthodontic wire including a spring portion between the first anchor portion and the second anchor portion to draw the first and second anchor teeth toward each other.

31. The method of claim 30, wherein the first anchor portion includes a first wire positioning guide and the second anchor portion includes a second wire positioning guide, the first wire positioning guide configured to mate with the lingual side of the first anchor tooth and the second wire positioning guide configured to mate with the lingual side of the second anchor tooth.

32. The method of claim 30, wherein the first anchor portion and the second anchor portion are bonded to the first and second anchor teeth by an orthodontic adhesive.

33. The method of claim 30, further comprising:
collecting images of the patient's teeth;
transmitting the images to a central processor; and
evaluating the collected images to develop the orthodontic treatment plan, the orthodontic wire selected based on the orthodontic treatment plan.

34. The method of claim 33, further comprising:
collecting updated images of the patient's teeth;
transmitting the updated images to the central processor; and
evaluating the collected updated images to develop an updated orthodontic treatment plan, the central processor utilizes the updated images to adjust the orthodontic treatment plan to develop the updated orthodontic treatment plan at an orthodontic appointment.

35. The method of claim 34, wherein the central processor selects an updated orthodontic wire as part of the updated treatment plan.

36. The method of claim 35, wherein the collected images of the patient's teeth include a center open image, a center closed image, a left buccal image, an upper arch image, a right buccal image and a lower arch image.

37. The method of claim 30, wherein the first anchor portion is bonded to the first anchor tooth and the second anchor portion is bonded to the second anchor tooth such that a compression force is applied to the first and second anchor portions by the spring portion.

38. The method of claim 30, wherein the first anchor portion includes a first wire positioning guide and the second anchor portion includes a second wire positioning guide, the first wire positioning guide bonded to the first anchor tooth when the first anchor portion is bonded to the first anchor tooth and the second wire positioning guide bonded to the second anchor tooth when the second anchor portion is bonded to the second anchor tooth.

39. A method for moving a patient's teeth, including an anchor tooth, a first active tooth and a second active tooth to a desired position, the anchor tooth positioned between the first and second active teeth, the method comprising:
positioning an anchor portion of an orthodontic wire onto a lingual side of the anchor tooth;
positioning a first active portion of the orthodontic wire onto a surface of the first active tooth;
positioning a second active portion of the orthodontic wire onto a surface of the second active tooth; and
bonding the anchor portion to fix the anchor portion to the anchor tooth such that the active portion of the orthodontic wire applies forces to the first and second active teeth to move the first and second active teeth relative to the anchor tooth, the first and second active portions contacting the first and second active teeth and being slidable along surfaces of the first and second active teeth proximate the anchor tooth.

40. The method of claim 39, further comprising:
trimming the orthodontic wire proximate a first marginal ridge of the first active tooth; and
trimming the orthodontic wire proximate a second marginal ridge of the second active tooth.
